(19) United States
(12) Patent Application Publication
(10) Pub. No.: US 2003/0041903 A1
(43) Pub. Date: Mar. 6, 2003

(54) Method of dispensing adhesive and sealant

(76) Inventors: Tsunou Chang, Canton, MI (US); Gary J. Ciarelli, Milford, MI (US)

Correspondence Address: HARNESS, DICKEY & PIERCE, P.L.C., P.O. BOX 828, BLOOMFIELD HILLS, MI, 48303, US

(21) Appl. No.: 09/947,067

(22) Filed: Sep. 5, 2001

(51) Int. Cl. F16K 31/12

(52) U.S. Cl. 137/486

(57) ABSTRACT

A method of controlling the dispensing of adhesives or sealants uses actual flow rate measurements to generate an error signal which is used to correspondingly alter the flow rate with a controllable flow regulator.

### TECHNICAL FIELD

The present invention relates to a method and apparatus for simple and accurate dispensing of variable viscosity materials such as adhesives and sealants.

### BACKGROUND OF THE INVENTION

The viscosity of pumpable adhesives and sealants is highly unstable and unpredictable. It varies due to changes in batch variation, temperature, and flow rate, making the accurate dispensing of such materials extremely difficult.

Many designs are available today that attempt to control the dispensing flow of variably viscous materials. Although there are some differences between the methods, the equipment can be classified under two main categories of dispensing: positive displacement and variable orifice.

The positive displacement (also known as doser, shotmeter or gearmeter) works much like a syringe. It relies on some external means, usually a pump, to fill a pre-measured chamber. A mechanical device, such as a piston or a gear, then drives the adhesive or sealant out. The system uses the mechanical device's speed to adjust for the changes in flow rate. However, the system has several shortcomings. There is no guarantee that the chamber is totally filled, and due to the compressibility and the relaxation rate of material, the fluid does not necessarily move out of the chamber at the same rate as the piston moves into the chamber. Therefore, accurate flow rate may not be guaranteed. Moreover, because of the complexity of the many moving parts and seals the system can require major maintenance that is both time consuming and expensive.

The variable orifice functions under the same principle as a faucet. The variable orifice uses a ball and seat or a needle and seat to regulate the upstream fluid. Systems available on the market rely on establishing a relationship between the flow rate and the pressure. When dispensing the material, a flow rate is requested, the system converts the flow rate into its equivalent pressure, and it is this pressure that is actually regulated through the ball and seat. This kind of system monitors the average volume (average flow rate over a period of time) dispensed after a certain interval. If there is a discrepancy between the desired and actual volumes, the pressure is compensated by a certain percentage and then the volume is checked again. This process is repeated at regular intervals. This type of system is called closed loop on pressure with volume compensation. The drawback is that because the flow rate-pressure relationship may change rapidly, the system strains to keep up with updating the flow rate pressure relationship by a predetermined number or percentages. Moreover, since pressure plays a role in their control, these systems require that additional pressure sensors be installed in the system, which leads to increased cost and maintenance. While these systems are effective, there is room in the art for a device and method that measures and corrects flow directly and simply.

### SUMMARY OF THE INVENTION

The present invention improves the variable orifice design by using a closed loop on flow rate. The invention includes a flowmeter that monitors flow rate directly, a flow regulator downstream of the flowmeter that controls the amount of fluid passing through the regulator, and a controller that corrects any errors in flow rate measured by the flowmeter. The controller reacts to the error and with a control algorithm generates a correction factor.

In an alternate embodiment, errors in flow rate are corrected by a proportional-integral-derivative (PID) loop that compensates for these errors.

In either case, the output from the control loop is then sent to a pressure transducer linked between the controller and the flow regulator. The pressure transducer sends a pneumatic signal to the flow regulator and instructs the flow regulator to adjust flow according to the correction determined by the controller. The result is a superior, faster and more accurate method of correcting for flow rate errors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a schematic diagram of a preferred embodiment of the present invention; and

FIG. 2 shows a flow chart of the control logic of the present invention.

### DETAILED DESCRIPTION OF THE PREFERRED EMBODIMENTS

The following description of the preferred embodiments is merely exemplary in nature and is in no way intended to limit the invention, its application, or uses.

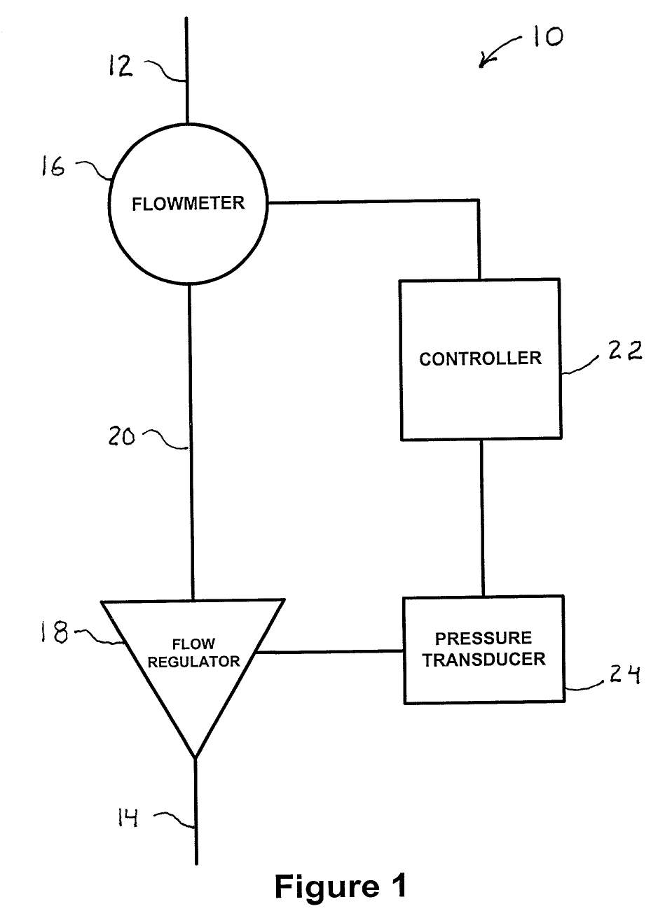

Referring now to the drawings, FIG. 1 shows a schematic for a metering device 10 according to the teachings of the present invention. In the preferred embodiment, the metering device 10 is attached to a robotic arm and functions automatically. However, any number of other industrial applications may be used.

The metering device 10 has an inlet 12 and an outlet 14. A flowmeter 16 is attached to a downstream end of inlet 12. In the preferred embodiment, the flowmeter is a pulse output type wherein fluid drives a gear wheel whose teeth generate a pulse signal. One acceptable product line of such flowmeters is the SRZ Series of positive displacement flowmeters commercially available from AW Company. Alternatively, a turbine type meter may also be used.

A flow regulator 18 is attached to the upstream end of outlet 14. In the preferred embodiment, the flow regulator 18 contains a ball and seat valve that regulates the flow of material through the flow regulator 18. One acceptable regulator is the SST fluid regulator commercially available from Graco Inc. However, any device capable of regulating the flow of a material may be used. The flowmeter 16 and the flow regulator 18 are joined by a fluid connection 20.

A controller 22 is electronically coupled to flowmeter 16. The controller 22 may be any electronic processing device, a computer chip and associated peripheral components in the preferred embodiment. A pneumatic pressure transducer 24 is electronically coupled to the controller 22 and pneumatically connected to the flow regulator 18.

A variably viscous fluid, such as a sealant or an adhesive, enters the device through the inlet 12. The fluid passes through the flowmeter 16 and through the fluid connection 20. The fluid then passes through the flow regulator 18 before exiting the metering device 10 through the outlet port 14.

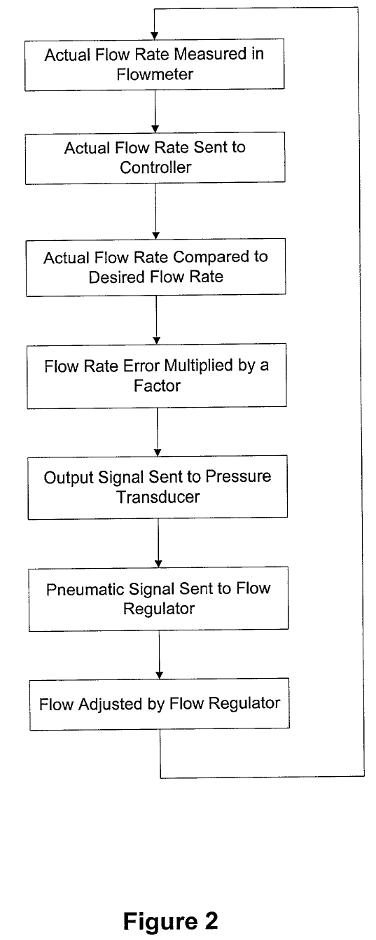

Shown in FIG. 2 is a flow diagram illustrating the control algorithm of the present invention. As the variably viscous fluid passes through the flowmeter 16, the flowmeter 16 measures the actual flow rate of the fluid and generates a signal indicative of the flow rate. The flowmeter 16 sends this signal electronically to the controller 22. The controller 22 converts the signal to real time flow rate and compares the actual flow rate to a desired flow rate determined either by an operator or robotic input or a programmed value. If the actual flow rate is not equal to the desired flow rate, the controller computes the error between the two and determines a gain factor. This new value, an output signal, is then sent to the pressure transducer 24.

In an alternate embodiment of the present invention, a proportional-integral-derivative calculation uses the error as an input and calculates an output signal to the pressure transducer 24.

The pressure transducer 24 converts the output signal into a pneumatic signal. The pneumatic signal is sent to the flow regulator 18. The flow regulator 18 then adjusts the actual flow of fluid passing through the flow regulator 18. In this way, the flow rate of the fluid passing through the dispensing device 10 may be continuously monitored with corrections to the flow made as needed.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of controlling the dispensing of adhesives or sealants from a dispensing conduit, the method comprising the steps of:
measuring a flow rate of the adhesive or sealant in the dispensing conduit;
comparing measured flow rate to a preselected reference value;
generating an output signal related to a difference between the measured flow rate and the reference value; and
altering the flow rate as a function of the output signal.

2. The method of claim 1 wherein the output signal is generated using a proportional integral derivative calculation method.

3. The method of claim 1 wherein the step of altering the flow rate is performed by a transducer having an input coupled for receipt of the output signal and an output coupled to a control input of a flow regulator in the dispensing conduit.

4. The method of claim 1 wherein the flow rate is measured by a positive displacement flowmeter positioned in the dispensing conduit.

5. A closed loop or flow rate method of controlling the dispensing of adhesives or sealants having variable viscosity from a dispensing conduit, the method comprising the steps of:
directly measuring a flow rate of the adhesive or sealant in the dispensing conduit with a flowmeter positioned at a first preselected location in the dispensing conduit;
comparing a first signal generated by the flowmeter representing measured flow rate with a second signal representing a preselected reference flow rate in a controller having an input coupled to the flowmeter;
generating a controller output signal in the controller by operating on the first and second signals with a predetermined algorithm;
passing the controller output signal to a transducer element having an input coupled to an output of the controller and an output, the transducer operative to generate a control signal at its output related to the error signal; and
altering the flow rate with a flow regulator positioned at a second preselected location in the dispensing conduit downstream of the first preselected location, the flow regulator having a control input coupled for receipt of the control signal.

6. The method of claim 5 wherein the predetermined algorithm comprises a proportional integral derivative computation method.

7. The method of claim 5 wherein the transducer element comprises a pressure transducer and the flow regulator is pneumatically operated.
